(19) United States
(12) Patent Application Publication
(10) Pub. No.: US 2010/0112981 A1
(43) Pub. Date: May 6, 2010

(54) WHITELIST UPDATE METHOD AND APPARATUS FOR USER EQUIPMENT IN MOBILE COMMUNICATION SYSTEM

(75) Inventors: Kyung Joo SUH, Seoul (KR); Chae Gwon LIM, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/610,558

(22) Filed: Nov. 2, 2009

(30) Foreign Application Priority Data
Nov. 3, 2008 (KR) 10-2008-0108581

(51) Int. Cl. H04M 1/66

(52) U.S. Cl. 455/411

(57) ABSTRACT

A method and apparatus for updating a whitelist in a mobile communication system are disclosed. The user equipment can selectively update the whitelist when connecting to the mobile communication system not only through a macro base station but also through a femtocell base station. The apparatus includes a User Equipment (UE), a Mobility Management Entity (MME), a macro base station (eNB), and a femtocell base station (HeNB).

### PRIORITY

This application claims the benefit under 35 U.S.C. §119(a) of a Korean patent application filed in the Korean Intellectual Property Office on Nov. 3, 2008 and assigned Ser. No. 10-2008-0108581, the entire disclosure of which is hereby incorporated by reference.

### BACKGROUND OF THE INVENTION

1. Field of the Invention

The present invention relates to a mobile communication system. More particularly, the present invention relates to a method and apparatus for providing a whitelist of accessible femtocell base stations to a user equipment in a mobile communication system.

2. Description of the Related Art

Recently, techniques have been developed to provide communication services using miniaturized base stations in a mobile communication system. An example of the miniaturized base station is a 3rd Generation Partnership Project (3GPP) Home evolved Node B (HeNB).

The term “femtocell” indicates a cell covering a very narrow area in a cellular system, and a base station managing a femtocell is termed a femtocell base station. The femtocell base station is a small and low-power indoor base station for homes or offices. A femtocell has the same meaning as a picocell or may be considered to be an evolved form thereof in terms of function. The femtocell base station is a small cellular base station that is connected to a broadband router, and sends and receives 2G and 3G voice and data signals through a Digital Subscriber Line (DSL) link and the like to and from a backbone network of an operator.

In 3GPP Long Term Evolution (LTE) Release 8, two types of base stations, evolved Node B (eNB) and Home evolved Node B (HeNB). The eNB is a macro base station managing a regular macro cell, and the HeNB is a femtocell base station.

A femtocell base station has a narrow coverage area, aiming to support several user equipments in a household, and may place restrictions on the number of connectable user equipments.

It is currently expected that 500 femtocell base stations may be deployed per sector in a mobile communication system with an Inter-Site Distance (ISD) of 500 m. To cover a dense apartment complex having 6000 households under the assumption that the cell radius is 400 m and the usage rate of femtocell base stations is 50 percent, 1000 femtocell base stations have to be deployed per sector. In such a dense environment, a user equipment cannot access all femtocell base stations and frequent handovers are required to maintain a connection. When a user equipment accesses a prohibited femtocell base station, security problems may occur. Hence, it is necessary for a femtocell base station to manage allowed user equipments. Further, it is necessary for a user equipment not to attempt to access prohibited femtocell base stations, and to store a list of accessible femtocell base stations as a whitelist.

However, schemes to create and update a whitelist have not been fully developed. In a proposed scheme, when a user equipment accesses a femtocell base station, the user equipment updates the whitelist to include the femtocell base station as an accessible one. When the user equipment attempts to access a femtocell base station and fails, the user equipment updates the whitelist to include the femtocell base station as an inaccessible one.

With such a scheme, the whitelist is updated as to femtocell base stations which the user equipment has attempted to access, and is not updated as to femtocell base stations which the user equipment has not yet attempted to access. Hence, the whitelist may be unable to provide sufficient information regarding accessible base stations or cells.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for managing a whitelist containing information regarding femtocell base stations accessible by a user equipment through an interface between the user equipment and a network device in a mobile communication system.

The present invention also provides a whitelist update method wherein, in a mobile communication system including femtocell base stations and supporting the Non-Access Stratum (NAS) protocol, the whitelist of accessible femtocell base stations can be updated using NAS protocol messages.

To update the whitelist using NAS protocol messages, the present invention provides an apparatus that includes a user equipment, a Mobility Management Entity (MME), a macro base station (e.g., evolved Node B (eNB)), and a femtocell base station (e.g., Home eNB (HeNB)). In addition, the present invention provides a method that enables the user equipment to update the whitelist based on NAS protocol messages including a whitelist update request message and a whitelist update response message exchanged between the user equipment and MME.

In accordance with an aspect of the present invention, a whitelist update method in a mobile communication system is provided. The method includes creating, by a User Equipment (UE), an L3 message containing a whitelist update request indication, and sending the created L3 message through an HeNB to an MME, determining, after receiving the L3 message, by the MME, whether the UE is valid, and creating, when the UE is allowed to access the HeNB, by the MME, an L3 response message containing whitelist information, and sending the created L3 response message to the UE.

Determining whether the UE is valid may include determining whether the UE is allowed to access the HeNB based on the Closed Subscriber Group IDentity (CSG ID) of the HeNB to which the UE is connected. Creating an L3 message containing a whitelist update request indication may be performed when the UE determines that whitelist update is necessary or receives a request for whitelist update from a network element managing the UE. The L3 response message created by the MME may contain at least one of whitelist information and a whitelist update result indication. The L3 message may be a Tracking Area Update (TAU) request message and the L3 response message may be a TAU accept message.

In accordance with another aspect of the present invention, a whitelist update method in a mobile communication system is provided. The method includes creating, by a UE, an L3 message containing a whitelist update request indication, and sending the created L3 message, examining, when the L3 message is received through an HeNB, by the MME, the CSG ID, and creating, when the UE is allowed to access the HeNB, an L3 response message containing whitelist information and sending the created L3 response message to the UE, and examining, when the L3 message is received through an eNB, by the MME, the Network Unique Cell Identity (NUCI), and creating, when the eNB is valid, an L3 response message containing whitelist information and sending the created L3 response message to the UE.

In accordance with yet another aspect of the present invention, a whitelist update apparatus in a mobile communication system is provided. The apparatus includes an HeNB, an eNB, a UE for creating an L3 message containing a whitelist update request indication and for sending the created L3 message to the HeNB or the eNB, and for receiving an L3 response message via the HeNB or the eNB and for updating a whitelist, an MME for examining, when the L3 message is received through the HeNB, the CSG ID, for creating, when the UE is allowed to access the HeNB, an L3 response message containing whitelist information, for sending the created L3 response message to the HeNB, for further examining, when the L3 message is received through the eNB, the NUCI, for creating, when the eNB is valid, an L3 response message containing whitelist information, and for sending the created L3 response message to the eNB.

In an exemplary implementation of the present invention, the user equipment may selectively update the whitelist when connecting to a mobile communication system not only through a macro base station (e.g., eNB) but also through a femtocell base station (e.g., HeNB). In particular, the user equipment may directly receive whitelist update information from a network device, or the network device may inform the user equipment of the possibility of whitelist update. Hence, the traffic from the network device to the user equipment can be adjusted, and the procedure for whitelist update can be efficiently managed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a mobile communication system according to an exemplary embodiment of the present invention;

FIG. 2 is a sequence diagram illustrating a whitelist update procedure involving a femtocell base station (e.g. Home evolved Node B (HeNB)) through Non-Access Stratum (NAS) protocol messages according to an exemplary embodiment of the present invention;

FIG. 3 is a sequence diagram illustrating a whitelist update procedure involving a macro base station (e.g., eNB) through NAS protocol messages according to another exemplary embodiment of the present invention; and

FIG. 4 is a flowchart illustrating a procedure performed by the Mobility Management Entity (MME) to support whitelist update in the user equipment according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention are described on the basis of the Third Generation Partnership Project (3GPP) Evolved Packet System (EPS), and may be applied to any mobile communication system employing the Non-Access Stratum (NAS) protocol or a similar one.

Exemplary embodiments of the present invention relate to a method and apparatus that enable a user equipment to update the whitelist when connecting to a mobile communication system employing the NAS protocol not only through a macro base station (e.g, eNB) but also through a femtocell base station (e.g., HeNB). That is, in a mobile communication system including femtocell base stations and supporting the NAS protocol, the whitelist of accessible femtocell base stations can be updated using NAS protocol messages.

To update the whitelist using NAS protocol messages, an exemplary embodiment of the present invention provides an apparatus that includes a User Equipment (UE), a Mobility Management Entity (MME), a macro base station (e.g., eNB), and a femtocell base station (e.g., HeNB). An exemplary embodiment of the present invention also provides a method that enables the user equipment to update the whitelist on the basis of NAS protocol messages including a whitelist update request message and a whitelist update response message exchanged between the user equipment and MME.

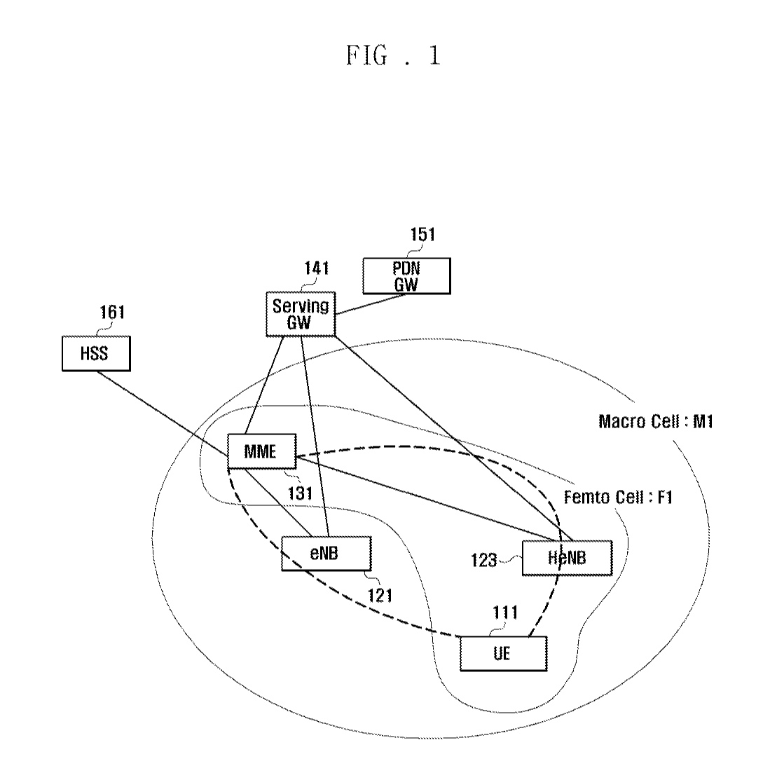

FIG. 1 illustrates a mobile communication system supporting whitelist update according to an exemplary embodiment of the present invention. The system illustrated in FIG. 1 is based on an architecture of the 3GPP EPS. The system employs the NAS protocol to support whitelist update for the user equipment. Those skilled in the art may understand that the whitelist update method described in connection with FIG. 1 is applicable through minor modifications to any mobile communication system having similar technical backgrounds, channels, architectures, protocols, or functions with slightly different protocols. It is therefore to be understood that any reference in the following description to a specific word or terminology associated with a specific standard is merely for sake of convenience and is not to be construed as limiting the application of the present invention.

Referring to FIG. 1, an eNB 121 and an HeNB 123 each establish wireless connections for communication with a UE 111 in their serving cells. The UE 111 is a mobile terminal that connects to a packet data network such as the Internet through a Serving GateWay (S-GW) 141. The Packet Data Network GateWay (PDN-GW) 151, a principal network element, acts as the Home Agent (HA). The MME 131 performs mobility, location and registration management for user equipments. The Home Subscriber Server (HSS) 161 connected through an interface to the MME 131 manages authentication information and service information related to subscribers and user equipments.

When the UE 111 is located in the service area of the eNB 121, the eNB 121, MME 131 and S-GW 141 cooperate with each other to provide a data path to the UE 111 and manage mobility thereof. When the UE 111 is located in the service area of the HeNB 123, the HeNB 123, MME 131 and S-GW 141 cooperate with each other to provide a data path to the UE 111 and manage mobility thereof.

Other network elements (not shown) may be added to the system of FIG. 1, and those network elements not directly related to the subject matter of the present invention are not described for clarity and conciseness.

The femtocell F1 of the HeNB 123 may be included in the macro cell M1 of the eNB 121 as illustrated in FIG. 1, or may or may not overlap with the macro cell M1. This may be evident to those skilled in the art.

For whitelist update, the UE 111 creates a Layer 3 (L3) message containing a whitelist update request indication and sends the L3 message to the HeNB 123 or the eNB 121, and receives, as a reply, an L3 response message via the HeNB 123 or the eNB 121 and updates the whitelist. Upon reception of the L3 message via the HeNB 123, the MME 131 examines a Closed Subscriber Group IDentity (CSG ID), and, if the UE 111 is allowed to access the HeNB 123, creates the L3 response message containing whitelist information and sends the L3 response message to the HeNB 123. Upon reception of the L3 message via the eNB 121, the MME 131 examines the Network Unique Cell Identity (NUCI), and, if the eNB 121 is valid, creates the L3 response message containing whitelist information and sends the L3 response message to the eNB 121. The HSS 161 stores information regarding subscribers including whitelists, and sends a selected whitelist to the MME 131 upon request.

The UE 111 communicates with the MME 131 through the NAS protocol for mobility, location, registration, and session management. That is, the MME 131 is a network element introduced for mobility, location and session management of the UE 111. Next, an exemplary procedure performed by the UE 111 and MME 131 through the NAS protocol to update the whitelist is described with reference to FIGS. 1 to 4.

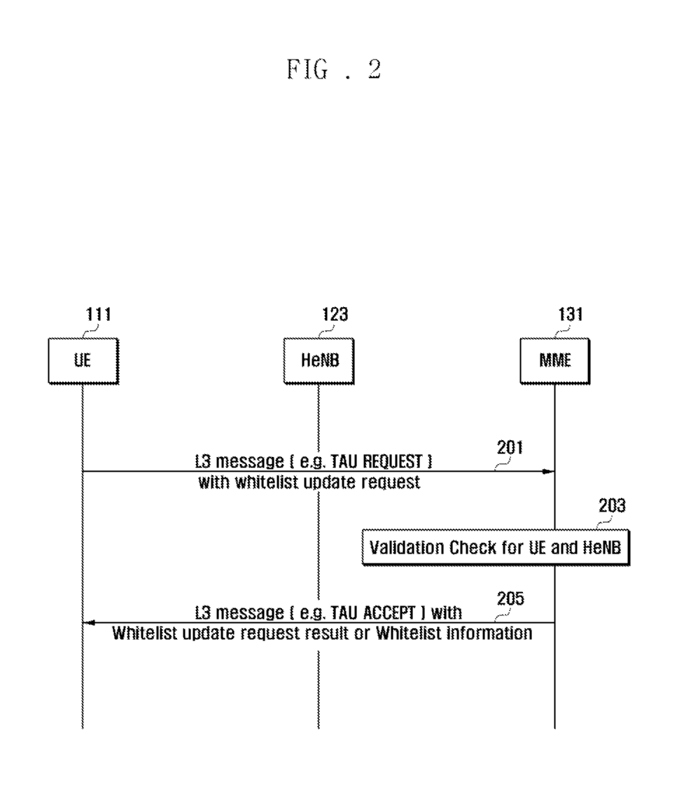

FIG. 2 is a sequence diagram illustrating a whitelist update procedure involving an HeNB and performed by a UE and an MME through an NAS protocol according to an exemplary embodiment of the present invention.

Operations to be described in connection with FIG. 2 are a part of the NAS protocol procedure, and whitelist update for the UE 111 is performed by inserting Information Elements (IE) described below in Table 1 to Table 5 in messages exchanged during the procedure of FIG. 2, which depicts an exemplary procedure for whitelist update when the UE 111 and MME 131 exchange NAS messages through the HeNB 123.

Referring to FIG. 2, upon determining that whitelist update is necessary or upon receiving a request for whitelist update from a network element managing the UE 111, the UE 111 sends an L3 message (NAS message) to the MME 131 to inform of the necessity of whitelist update in step 201. That is, the UE 111 sends an L3 message containing a whitelist update request indication to the MME 131. Here, the L3 message may be a Tracking Area Update (TAU) request message, a service request message, a TAU accept message, a UE context setup request message, attach request message, or NAS transport message.

The information to set the whitelist update request indication is described below in connection with Table 1 and Table 2.

TABLE 1

| 8 7 6 5 | 4 | 3 2 1 | |
|---|---|---|---|
| Whitelist Update | Spare | Request type value | Octet 1 |
| Request Type IEI | | | |

Table 1 illustrates an IE for the whitelist update request indication, which is utilized to inform the MME 131 of a whitelist update. This IE requires a total of 8 bits. The fifth to eighth bits are used for the IE Identifier (IEI), which is set to a value defined by 3GGP or a standardization body. The first to third bits are used to indicate the presence of a whitelist update request, and may be set to a value defined in Table 2.

TABLE 2

| bits | |
|---|---|
| 3 2 1 | Request type value |
| 0 0 0 | Whitelist Update not Requested |
| 0 0 1 | Whitelist Update Requested |
| Others | Reserved |

Table 2 illustrates values assigned for the presence of a whitelist update request. As shown in Table 2, among possible 3-bit patterns, bit patterns 000 and 001 can be used to set the first to third bits (000 for the absence of a whitelist update request and 001 for the presence of a whitelist update request).

The L3 message from the UE 111 to the MME 131 may be a TAU request message or a service request message. In the case of a service request message, the identifier of a femtocell base station (closed subscriber group ID or CSG ID) accepting a service request may be added to the whitelist. This may be applied to the case where rapid processing is required in comparison to other L3 messages requiring a relatively long processing time.

Upon reception of the L3 message, the MME 131 checks the validity of the UE 111 and HeNB 123 in step 203. That is, the MME 131 determines whether the UE 111 is allowed to access the MME 131. For validation, the Global Unique Temporary Identifier (GUTI) may be utilized. In the case of the HeNB 123, the Network Unique Cell Identity (NUCI) of the S1 interface may be utilized. In the case of the femtocell, the HeNB identifier may be utilized. The NUCI includes a CSG ID, and it is possible to determine whether the UE 111 is allowed to access the MME 131 on the basis of the CSG ID. For validity checking, the MME 131 may obtain whitelist information from the HSS 161 managing subscriber information or from an Operations and Management server (O&M server, not shown).

The MME 131 sends an L3 response message to the UE 111 in step 205. If the UE 111 is allowed to access a particular HeNB, the L3 response message contains at least one of whitelist information and a whitelist update result indication. The L3 response message may be a TAU accept message. The L3 response message is detailed further with reference to the IE given in Table 3 to Table 5.

TABLE 3

| 8 7 6 5 | 4 | 3 2 1 | |
|---|---|---|---|
| Whitelist Update Request | Spare | Response type | Octet 1 |
| Type IEI | | value | |

Table 3 illustrates an IE for whitelist update results, which may be contained in a TAU accept message sent from the MME 131 to the UE 111 to inform the UE 111 of the results corresponding to the whitelist update request. This IE requires a total of 8 bits. The fifth to eighth bits are used for the IE Identifier (IEI), which is set to a value defined by 3GGP or a standardization body. The first to third bits are used to indicate the results of an NAS whitelist update request, and may be set to a value defined in Table 4.

TABLE 4

| bits | |
|---|---|
| 3 2 1 | Response type value |
| 0 0 0 | No Update Requested |
| 0 0 1 | List Update Request Success |
| 0 1 0 | Update Request not Accepted |
| Others | Reserved |

Table 4 illustrates values assigned to the results of a whitelist update request. As shown in Table 4, the first to third bits are used. The bit pattern 000 indicates no whitelist update request, the bit pattern 001 indicates success of the whitelist update request, and the bit pattern 010 indicates rejection of the whitelist update request.

TABLE 5

| 8 7 6 5 4 3 2 1 | |
|---|---|
| Whitelist IEI (IE Identifier) | Octet 1 |
| Length of Whitelist IE | Octet 2 |
| Whitelist 1 | Octet 3-6 |
| Whitelist 2 | Octet 7-11 |
| Whitelist 3 | Octet — |

Table 5 illustrates an IE for whitelist information, which may be contained in a TAU accept message sent from the MME 131 to the UE 111 to deliver specific whitelist information. That is, this IE may be used to deliver specific whitelist information corresponding to success of the whitelist update request.

In Table 5, Octet 1 is used to set a value for the whitelist IEI, which may be defined by a standardization body. Octet 2 is used to indicate the total length of the present whitelist IE. Octet 3 to Octet 11 are used for individual whitelist information, i.e. CSG IDs.

The IE defined in Table 5 may be used along with the IE defined in Table 3. For example, when the IE defined in Table 3 is used to indicate success of the whitelist update request, the IE defined in Table 5 may be used to deliver specific whitelist information. That is, to indicate only success of a whitelist update request, the IE defined in Table 3 may be coded using the value specified in Table 4. To both indicate success of a whitelist update request and deliver specific whitelist information, the IE defined in Table 3 and the IE defined in Table 5 may be used together.

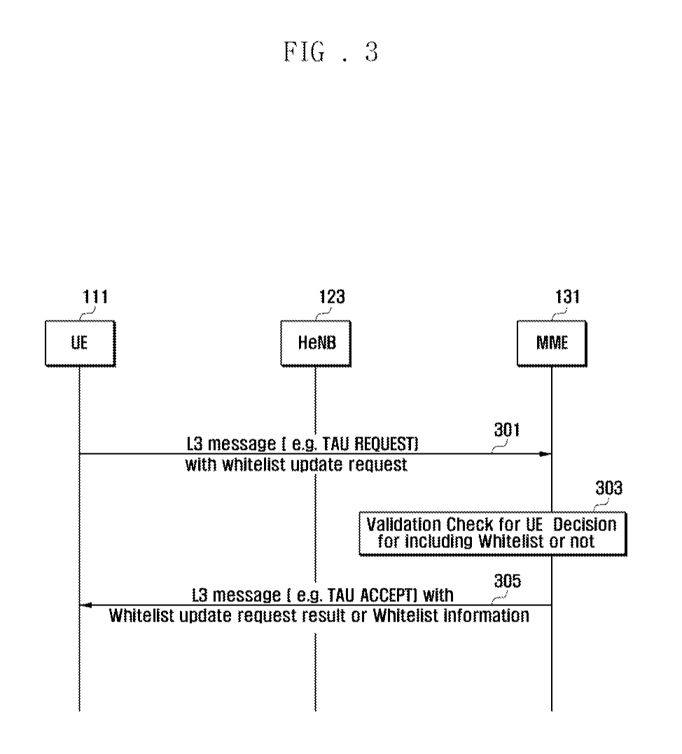

FIG. 3 is a sequence diagram illustrating a whitelist update procedure involving an eNB and performed by a UE and an MME through a NAS protocol according to an exemplary embodiment of the present invention.

Operations to be described in connection with FIG. 3 are a part of the NAS protocol procedure, and whitelist update for the UE 111 is performed by inserting IEs described in Table 1 to Table 5 in messages exchanged during the procedure of FIG. 3, which depicts a procedure for whitelist update when the UE 111 and MME 131 exchange NAS messages through the eNB 121.

Referring to FIG. 3, upon determining that whitelist update is necessary or upon receipt of a request for whitelist update from a network element managing the UE 111, the UE 111 sends an L3 message (NAS message) to the MME 131 to inform of the necessity of whitelist update in step 301. The L3 message contains a whitelist update request indication. The information to set the whitelist update request indication is described in connection with Table 1 and Table 2.

Upon receipt of the L3 message, the MME 131 checks the validity of the UE 111 in step 303. That is, the MME 131 determines whether the UE 111 is allowed to access the MME 131 on the basis of the identifier of the UE 111 (for example, GUTI). The MME 131 may obtain whitelist information from the HSS 161 managing subscriber information or from the O&M server, and may provide its own whitelist information to the UE 111 upon request. At step 303, the MME 131 determines whether to send a whitelist to the UE 111. This determination depends on the policy of the network operator or other conditions.

The MME 131 sends an L3 response message to the UE 111 in step 305. If the UE 111 is valid, the L3 response message contains at least one of whitelist information and a whitelist update result indication. The L3 response message may be a TAU accept message. The whitelist information and whitelist update result indication in the L3 response message may be coded with reference to Table 3 to Table 5.

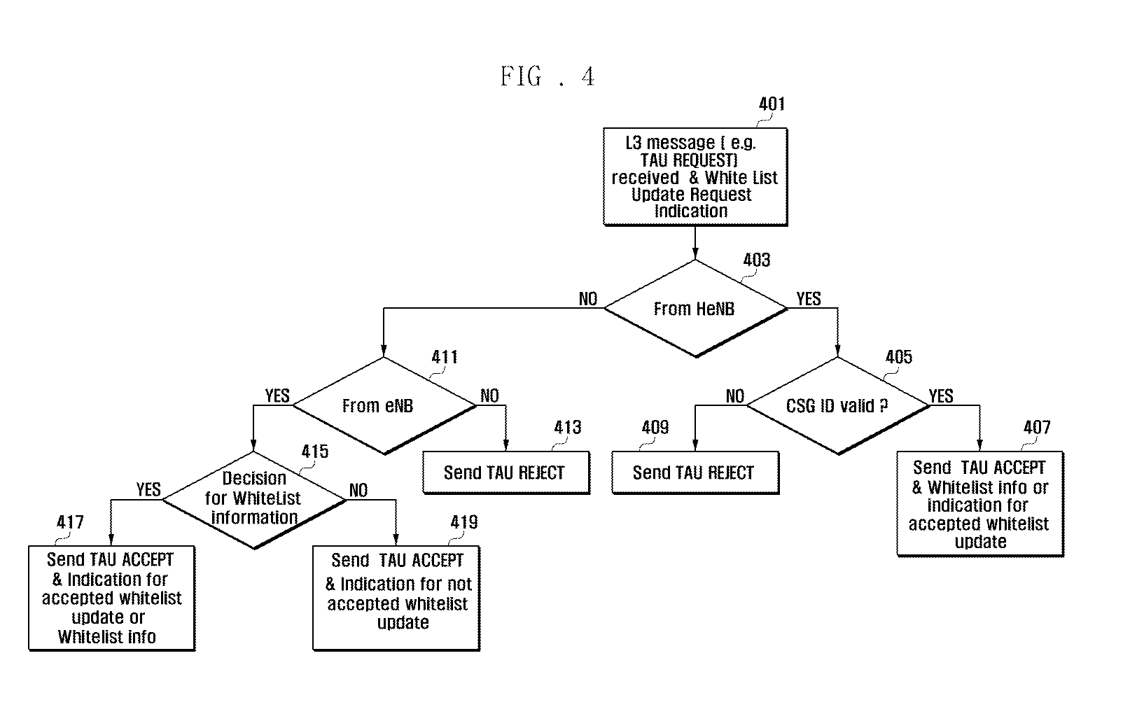

FIG. 4 is a flowchart illustrating a procedure performed by an MME to support whitelist update in a UE according to an exemplary embodiment of the present invention.

In the procedure of FIG. 4, TAU-related messages are used as examples of L3 messages. However, other L3 messages such as a service request message may also be used in the procedure of FIG. 4.

Referring to FIG. 4, as described before, the UE 111 may send an L3 message (for example, a TAU request message) containing a whitelist update request indication to the MME 131 through the eNB 121 or the HeNB 123. The MME 131 receives an L3 message containing a whitelist update request indication in step 401, and determines whether the L3 message has been sent through the HeNB 123 on the basis of the NUCI of the S1 interface or the HeNB identifier in step 403.

If it is determined in step 403 that the L3 message has been sent through the HeNB 123, the MME 131 determines whether the CSG ID in the NUCI or HeNB identifier is valid in step 405. That is, whether the HeNB 123 is allowed to access the MME 131 can be determined on the basis of the CSG ID. If it is determined in step 405 that the CSG ID is invalid, the MME 131 sends a TAU reject message to the UE 111 (i.e. access denied) in step 409. In contrast, if it is determined in step 405 that the CSG ID is valid, the MME 131 sends a TAU accept message to the UE 111 in step 407. Here, the TAU accept message contains at least one of whitelist information and a whitelist update success indication.

In contrast, if it is determined in step 403 that the L3 message has not been sent through the HeNB 123, the MME 131 determines whether the L3 message has been sent through a valid eNB in step 411. Whether the L3 message has been sent through a valid eNB can be determined on the basis of the NUCI. If it is determined in step 411 that the L3 message has not been sent through a valid eNB, the MME 131 sends a TAU reject message to the UE 111 in step 413. In contrast, if it is determined in step 411 that the L3 message has been sent through a valid eNB, the MME 131 determines whether to send whitelist information to the UE 111 in step 415. Here, the MME 131 determines whether to permit whitelist update for a UE connected through an eNB according to the policy of the network operator or other operation policies.

If it is determined in step 415 that whitelist information is to be sent, the MME 131 sends a TAU accept message containing at least one of whitelist information and a whitelist update success indication to the UE 111 in step 417. In contrast, if it is determined in step 415 that whitelist information is not to be sent, the MME 131 sends a TAU accept message containing an update request not accepted indication to the UE 111 in step 419.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A whitelist update method in a mobile communication system, the method comprising:
creating, by a User Equipment (UE), a Layer 3 (L3) message containing a whitelist update request indication, and sending the created L3 message through a Home evolved Node B (HeNB) to a Mobility Management Entity (MME);
determining, after receiving the L3 message, by the MME, whether the UE is valid; and
creating, when the UE is allowed to access the HeNB, by the MME, an L3 response message containing whitelist information, and sending the created L3 response message to the UE.

2. The method of claim 1, wherein the determining of whether the UE is valid comprises determining whether the UE is allowed to access the HeNB based on a Closed Subscriber Group IDentity (CSG ID) of the HeNB to which the UE is connected.

3. The method of claim 2, wherein the creating of the L3 message is performed when the UE determines that a whitelist update is necessary or receives a request for a whitelist update from a network element managing the UE.

4. The method of claim 3, wherein the L3 response message created by the MME contains at least one of whitelist information and a whitelist update result indication.

5. The method of claim 4, wherein the L3 message comprises a Tracking Area Update (TAU) request message and the L3 response message comprises a TAU accept message.

6. A whitelist update method in a mobile communication system, the method comprising:
creating, by a User Equipment (UE), a Layer 3 (L3) message containing a whitelist update request indication, and sending the created L3 message;
examining, when the L3 message is received through a Home evolved Node B (HeNB), by a Mobility Management Entity (MME), a Closed Subscriber Group IDentity (CSG ID), and creating, when the UE is allowed to access the HeNB, an L3 response message containing whitelist information and sending the created L3 response message to the UE; and
examining, when the L3 message is received through an evolved Node B (eNB), by the MME, a Network Unique Cell Identity (NUCI), and creating, when the eNB is valid, an L3 response message containing whitelist information and sending the created L3 response message to the UE.

7. The method of claim 6, wherein the examining of the CSG ID and the creating of the L3 response message comprises:
determining whether the UE is allowed to access the HeNB based on the CSG ID of the HeNB to which the UE is connected; and
creating, when the UE is allowed to access the HeNB, an L3 response message containing whitelist information and sending the created L3 response message to the UE.

8. The method of claim 7, wherein the examining of the NUCI and the creating of the L3 response message comprises:
determining whether the eNB is valid based on the NUCI; and
creating, when the eNB is valid and whitelist updating for the UE is determined according to policies of a network operator, an L3 response message containing whitelist information and sending the created L3 response message to the UE.

9. The method of claim 8, wherein the L3 response message, created when the UE is allowed to access the HeNB, comprises at least one of whitelist information and a whitelist update result indication.

10. The method of claim 9, wherein the L3 message comprises a Tracking Area Update (TAU) request message and the L3 response message comprises a TAU accept message.

11. A whitelist update apparatus in a mobile communication system, the apparatus comprising:
a Home evolved Node B (HeNB);
an evolved Node B (eNB);
a User Equipment (UE) for creating a Layer 3 (L3) message containing a whitelist update request indication and for sending the created L3 message to the HeNB or the eNB, and for receiving an L3 response message via the HeNB or the eNB and for updating a whitelist;
a Mobility Management Entity (MME) for examining, when the L3 message is received through the HeNB, a Closed Subscriber Group IDentity (CSG ID), for creating, when the UE is allowed to access the HeNB, an L3 response message containing whitelist information, for sending the created L3 response message to the HeNB, for examining, when the L3 message is received through the eNB, a Network Unique Cell Identity (NUCI), for creating, when the eNB is valid, an L3 response message containing whitelist information, and for sending the created L3 response message to the eNB.

12. The apparatus of claim 11, further comprising a Home Subscriber Server (HSS) for storing subscriber information including whitelists, and for providing a whitelist to the MME.

13. The apparatus of claim 11, wherein the L3 response message comprises an indication for not accepted whitelist update request when the UE is not allowed to access the HeNB.

14. The apparatus of claim 11, wherein the L3 response message comprises an indication for not accepted whitelist update request when the eNB is invalid.

15. The apparatus of claim 11, wherein the L3 response message, created when the UE is allowed to access the HeNB, comprises at least one of whitelist information and a whitelist update result indication.

16. The apparatus of claim 15, wherein the L3 message comprises a Tracking Area Update (TAU) request message and the L3 response message comprises a TAU accept message.

17. A method for updating a whitelist in a mobile communication system, the method comprising:
creating, by a User Equipment (UE), a Layer 3 (L3) message containing a whitelist update request indication and sending the created L3 message to a Home evolved Node B (HeNB) or an evolved Node B (eNB);
receiving, by the UE, an L3 response message via the HeNB or the eNB from a Mobility Management Entity (MME), when the UE is allowed to access the HeNB or when the eNB is valid; and
updating, by the UE, the whitelist of the UE.

18. The method of claim 17, wherein an MME examines, when the L3 message is received through the HeNB, a Closed Subscriber Group IDentity (CSG ID), creates, when the UE is allowed to access the HeNB, the L3 response message containing the whitelist information, and sends the created L3 response message to the HeNB.

19. The method of claim 17, wherein the MME examines, when the L3 message is received through the eNB, a Network Unique Cell Identity (NUCI), creates, when the eNB is valid, the L3 response message containing the whitelist information, and sends the created L3 response message to the eNB.

20. The method of claim 17, wherein the L3 response message, created when the UE is allowed to access the HeNB, comprises at least one of whitelist information and a whitelist update result indication.
